(19) United States
(12) Patent Application Publication
(10) Pub. No.: US 2011/0200956 A1
(43) Pub. Date: Aug. 18, 2011

(54) Candle Holder

(76) Inventor: Damon L. Franklin, Queens Village, NY (US)

(21) Appl. No.: 12/816,251

(22) Filed: Jun. 15, 2010

Related U.S. Application Data
(63) Continuation-in-part of application No. 12/152,972, filed on May 20, 2008.
(60) Provisional application No. 61/070,810, filed on Mar. 27, 2008.

(51) Int. Cl. F21V 35/00; F23D 3/18

(52) U.S. Cl. 431/292; 431/289

(57) ABSTRACT

A candle holder that allows for the installed candle to be lit without having to remove the candle from the holder and that maintains the candle in an upright orientation as the orientation of the candle holder is varied. The candle holder includes a housing fixedly connected to an enclosure, the housing comprising, in one embodiment, a counterbalance with an annular top adapted to receive the candle. The present invention is also a candle holder with a pivotally connected candle tray that slides out of the housing to access the candle.

### CROSS-REFERENCE TO RELATED APPLICATIONS

This application is a continuation-in-part of, and claims the benefit of U.S. patent application Ser. No. 12/152,972, filed on May 20, 2008, which claims the benefit of U.S. Provisional Patent Application Ser. No. 61/070,810, filed on Mar. 27, 2008, both of which are expressly incorporated herein in their entireties by reference thereto.

### BACKGROUND OF THE INVENTION

1. Field of the Invention

The present invention relates to a candle holder, and more particularly, to a candle holder having a housing including a pivoting counterbalance capable of maintaining a candle in an upright position when the candle holder is rotated. The present invention is also a candle holder having a housing including a pivoting counterbalance and a gimbal capable of maintaining a candle in an upright position when the candle holder is rotated. The present invention is also a candle holder having a housing including a slide out candle tray for the candle that pivots on a pin in the housing.

2. Description of the Related Art

A variety of candle holders are known in the prior art. A candle holder generally has a body or fixture that receives the end of the candle. Candle holders with a glass cover are also known in the art. Also known are tall candles called hurricane candles and tall candle holders sometimes called hurricane candle holders. The disadvantage with these candle holders is that a user has to either tilt the candle holder or remove the candle from the holder in order to light it. Sometimes the user has to remove the glass enclosure to light the candle. In such a situation, the wax often undesirably drips out of the candle and out of the candle holder, sometimes onto the user's fingers or the surrounding counter or floor area. In situations where the glass is not removable, then, depending on the dimensions of the enclosure/envelope, the user may require something with a longer reach than a standard sized match or lighter to access the candle's wick such as a long reach lighter or matches, more commonly used to light fireplaces rather than candles.

When the user carries the currently known hurricane candle, it is not possible to maintain the candle in a consistently upright position due to shifts caused by the user's movement and/or the inconsistency of the surface being traversed. When a candle is not in a consistently upright position, there is always a chance for wax to drip out and/or over one's fingers which could result in the fingers getting burnt. The design of candle holders known in the prior art do not provide for a means of catching molten wax that may spill from the candle. Thus, the user has to walk very carefully while carrying the candle. Also, when the conventional burning hurricane candle holder candle is lit and kept in the holder on a table or counter, care has to be taken so that the enclosure and burning candle are not accidentally knocked over by a simple pushing or shoving, which could break the enclosure and would likely cause the candle to land in a position inconsistent with its original and intended upright orientation. Such an accidental occurrence could create the risk of a fire.

Candle holders having a pivoting fixture centrally located within a glass tube are also known in the art. The disadvantage of a candle holder with that configuration is that, given its limited ability to pivot the fixture about only a single axis, it cannot consistently maintain the candle in the upright position when the orientation of the candle holder changes in a direction inconsistent with the axis for rotation of the fixture. Additionally, because the fixture is centrally mounted within the glass enclosure, the difficulties with accessibility remain unaddressed. Also, the shape of the glass tube and the positioning of the candle within the glass tube only allow for heat dissipation from the top of the tube when the candle holder is placed on a flat surface. One last disadvantage of a candle holder with this configuration is that the glass tubes also functions as the supporting base. Depending on the texture and hardness of the surface or the degree or care utilized when handling the candle holder, the glass could become scratched, chipped or even break when put down onto a surface.

A candle holder is needed that has a durable, weighted base, that allows the user to light the candle without having to remove the candle from the holder and without need of a long lighter or match, that allows for convenient installation and removal of the candle, and that maintains the candle in a consistently upright position whether it is carried, moved or rocked about any axis. A candle holder is also needed that provides for the convenient lighting and replacement of a stable and secure candle within a tall enclosure, such as, for example, in the shape of a hurricane candle.

### SUMMARY OF THE INVENTION

A candle holder is described that comprises a counterbalance with a candle. The counterbalance fixture is pivotally positioned in a circular gimbal that is pivotally positioned in a housing. The housing may be weighted to provide stability for the candle holder either through the materials of construction or through additional weighting. The candle holder may also include an enclosure/envelope that is securely fastened with a proximal end or top of the housing. The candle holder has a first upright position and a second inverted position.

An aperture is defined in the housing to receive the gimbal and the counterbalance. The counterbalance has an upper annular portion and a lower portion. In one embodiment, the counterbalance includes a recess formed in the upper annular portion. A groove is adapted in a top surface of the counterbalance to receive a magnetic disc. The candle includes a wick, a wax ring, a wick tab, and a cover, which is removably mounted on top of the magnetic disc in the annular top of the counterbalance. The aluminum cover advantageously prevents spillage of wax when the candle has been lit, while the magnetic properties of the wick tab create resistance for the candle to move away from the magnetic disc fixedly attached to the annular top of the counterbalance.

The counterbalance is pivotally mounted in the gimbal with a first pair of pivot members adapted to rotate the counterbalance about an axis that is defined by the first pair of pivot members. The gimbal is pivotally mounted in the housing with a second pair of pivot members adapted to rotate the gimbal about an axis that is defined by the second pair of respective pivot members. The axis of the gimbal and the axis of the housing are preferably perpendicular with each other.

The candle is mounted in the annular top of the counterbalance such that the wick tab in the candle is positioned in contact with and on the magnetic disc of the counterbalance. The magnetic forces of attraction between the candle's wax tab and the magnetic disc removably yet securely holds the candle within the fixture. The candle holder has a first position in which the candle holder is upright along a longitudinal axis. The candle holder has a second position in which the candle holder is inverted along the longitudinal axis for lighting, removing and/or replacing the candle.

The candle is consistently upright in the first position and in the second position. The gyroscopic mechanics employed in the construction of the candle holder and the counterbalance maintains the fixture, and thereby the candle, in a consistently upright orientation, while the magnetic disc incorporated into the counterbalance help keeps the candle positioned. The candle in the candle holder is consistently upright in all orientations of the candle holder.

In another embodiment of the candle holder, a counterbalance with a candle is pivotally mounted in the housing. The candle remains approximately upright in all positions of the candle holder.

In yet another embodiment, the housing, at its distal end, contains one or more notches or apertures along its bottom edge and through one side of the housing that aid with heat dissipation for the candle holder. The notches can be any shape or configuration, such as, for example, arches, triangles, squares, rectangles (also referred to as parapets because of their similarity in appearance to the upper portion of a castle's wall), etc. Preferably, the notches are positioned along the surface of the housing opposite from which the enclosure is attached, creating a single or a series of openings through which air, heat and/or candle light can pass. The notches allow for additional air flow and more oxygen supply to the burning candle.

In another embodiment of the invention, the housing comprises a slide out tray pivotally connected to the housing. The slide out tray is rotationally connected to the housing with a pivot member such as a pin or hinge. Additionally, a groove or recess is included in the bottom surfaces of the tray and in the housing to receive a magnetic disc. The magnet discs help maintain the candle in the tray and the tray within the housing. This embodiment allows for the loading, lighting, and replacement of candles in the candle holder by sliding the tray out from its closed position, loading the candle, lighting it and returning the slide out tray to its original position within the housing.

### BRIEF DESCRIPTION OF THE DRAWINGS

FIG. 1 is a front perspective view of a candle holder in accordance with a preferred embodiment of the present invention;

FIG. 2 is an exploded front perspective view of the candle holder of FIG. 1;

FIG. 2A is a front perspective view of a counterbalance of the candle holder of FIG. 1;

FIG. 2B is a front perspective view of a counterbalance with a candle of the candle holder of FIG. 1;

FIG. 3 is an exploded front perspective view of a candle in accordance with a preferred embodiment of the present invention;

FIG. 4 is a perspective view of a method of mounting the candle in an annular top of a counterbalance;

FIG. 5 is a perspective view of a method of mounting the counterbalance in a gimbal of the candleholder of FIG. 1;

FIG. 6 is a perspective view of a method of mounting the gimbal with the counterbalance in a housing of the candleholder of FIG. 1;

FIG. 7A shows a first upright position of the candleholder of FIG. 1 in accordance with the preferred embodiment of the present invention;

FIG. 7B shows a second inverted position of the candleholder of FIG. 1 in accordance with the preferred embodiment of the present invention;

FIGS. 8A-C show positions of the candleholder of FIG. 1 while the orientation is changed from the first position to an intermediate position, and from the intermediate position to the second position;

FIG. 9 shows a perspective view of another embodiment of the candleholder of the present invention;

FIG. 10 shows an exploded front perspective view of the candle holder shown in FIG. 9;

FIG. 11 is a perspective view of another embodiment of the candleholder in accordance with the present invention;

FIG. 12 is an exploded view of the candleholder shown in FIG. 11;

FIG. 13 is top view of the counterbalance for the embodiment shown in FIG. 12;

FIG. 14 is a front view of the counterbalance for the embodiment shown in FIG. 12;

FIG. 15 is a left side view of the counterbalance for the embodiment shown in FIG. 12;

FIG. 16 is a cross sectional view of the counterbalance for the embodiment shown in FIG. 15 along axis R-R; and

FIG. 17 is a front view of an embodiment of a candle in accordance with the invention with protruding legs;

FIG. 18 is a perspective of another embodiment of the candleholder in accordance with the present invention;

FIG. 19 is an exploded view of the candleholder shown in FIG. 18;

FIG. 20 is a top view of the housing shown in FIG. 21;

FIG. 21 is a cross sectional view of the housing for the embodiment shown in FIG. 21 along axis A-A;

FIGS. 22A-C show the candleholder housing for another embodiment of the invention shown in a first position where it is closed and a second position where it is open and the underside of the candle tray; and

FIGS. 23 and 24 are perspective views of alternative embodiments for the candleholder in accordance with the present invention with alternative enclosure shapes, the shape of a wine bottle and with different housing configurations, one with and one without notches.

### DETAILED DESCRIPTION

Although specific terms are used in the following description for the sake of clarity, these terms are intended to refer only to a particular structure of the invention selected for illustration in the drawings, and are not intended to define or limit the scope of the invention.

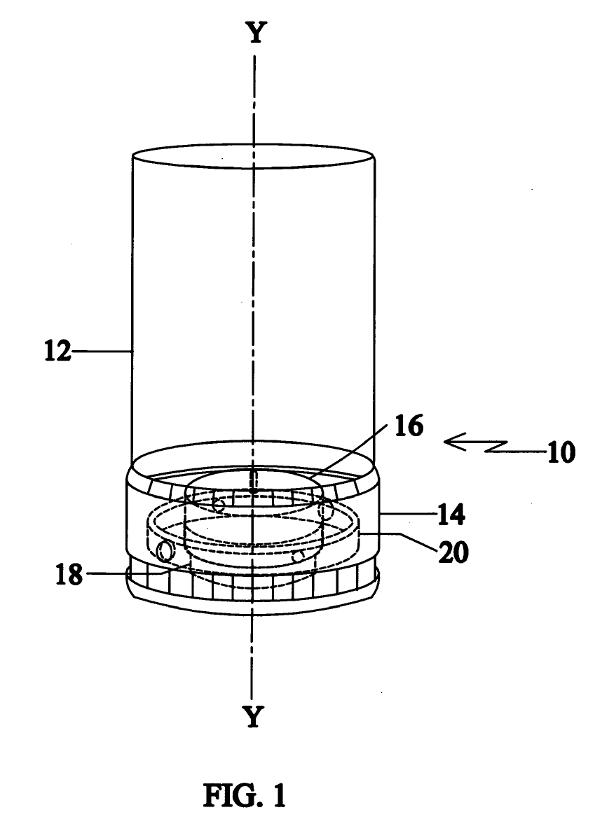

Referring to FIG. 1, a candle holder 10 in accordance with a preferred embodiment of the present invention is shown. The candle holder 10 includes an enclosure, envelope or cover 12 and housing 14. The enclosure 12 made of glass, stone or other noncombustible material used for candle holders or enclosures is fixedly and securely coupled with the housing 14. The housing 14 includes a candle 16 (although the candle itself need not be included as an integral part of the device) that is removably and securely positioned in a counterbalance 18. The counterbalance 18 is pivotally positioned in a gimbal 20 that is pivotally positioned in the housing 14. The candle holder 10 has a first upright position and a second inverted position.

In one embodiment of the invention, the housing is made of materials to increase the weight of the housing 14 relative to the enclosure 12, such as, for example brass, copper and other metals, composite materials, and fire resistant materials, to help stabilize the candle holder 10 and add stability to the device.

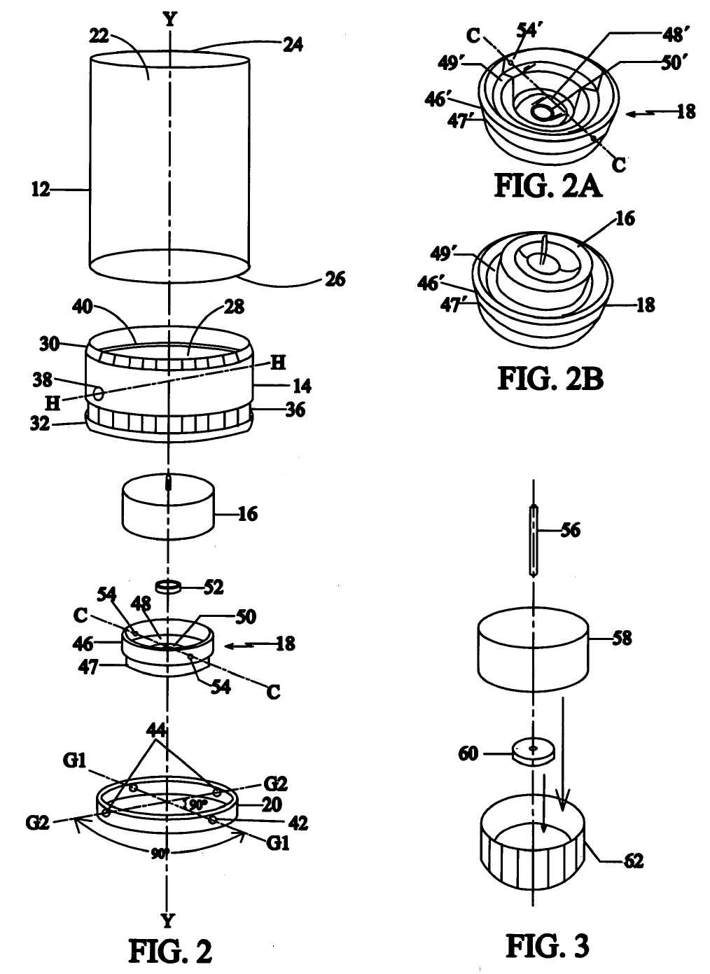

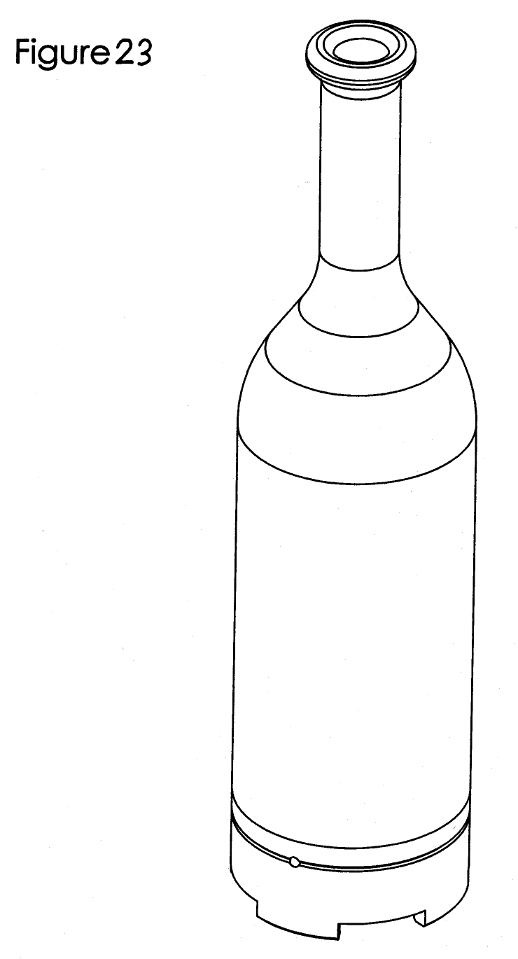

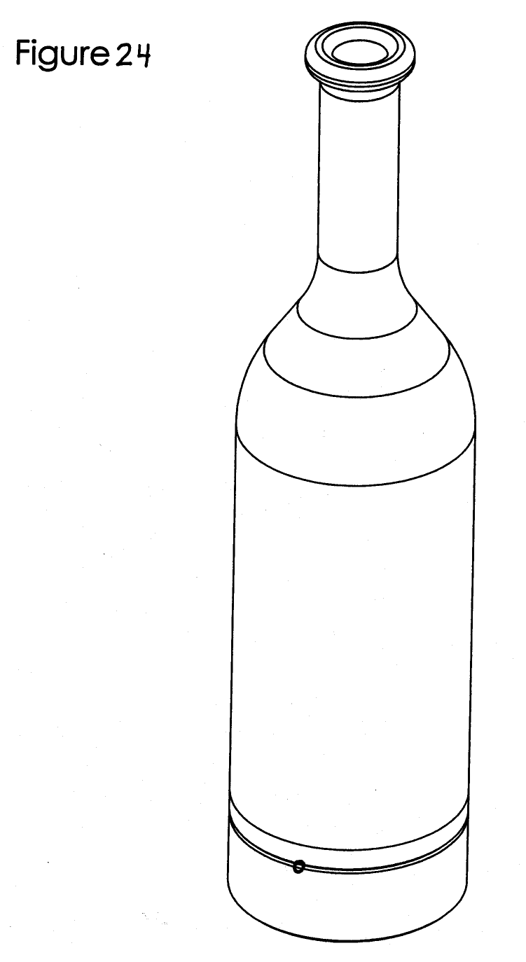

Referring to FIG. 2 an exploded view of the candle holder 10 in accordance with a preferred embodiment of the present invention is shown. The enclosure 12, preferably a glass or stone envelope, has an aperture 22 that is defined by an open proximal end 24 and an open distal end 26 along a longitudinal axis-Y. The enclosure 12 can be, but is not limited to, a translucent glass or acrylic cylinder of varying colors and geometric configurations (heights, widths, diameters, thicknesses, etc.), and may also be bottle shaped glass and/or a lantern shaped enclosure (as shown in FIGS. 23 and 24). The envelope 12 can also be, but is not limited to, a cylinder made of an opaque heat resistant material with perforations or apertures within the sides of the enclosure 12 to allow ventilation and to allow the candle's light to pass directly through the enclosure 12.

Preferably, the housing 14 is configured to be cylindrical, most preferably metallic construction (aluminum, brass or copper) but other materials of construction (including one or more materials) are possible. The housing 14 includes a through aperture 28 that is defined approximately centrally in the housing 14 by a proximal end 30 and a distal end 32 along the longitudinal axis-Y. An outer peripheral portion of housing 14 includes a groove 36 in proximity with the distal end 32 it being understood that the invention is not limited to embodiments comprising the groove 36. The groove 36 preferably includes a plurality of holes (not shown) though the housing 14. The holes provide a means for some direct light from the candle 16 and also provide for ventilation of the device and for air supply to the candle 16. In this preferred embodiment, the housing 14 also includes a pair of opposed through holes 38 on the outer periphery of the housing 14. The first pair of opposed holes 38 define an axis of housing-H. In this preferred embodiment, the drilled holes 38 are approximately ⅛-inches in diameter and are positioned approximately ⅝-inches up from the distal end 32 of the housing 14. The height of the housing 14 is approximately ⅓ the height of the enclosure 12 but the ratio of the heights is not limited to any specific numbers or range.

The aperture 28 includes an indentation 40 along an inner periphery in proximity with proximal end portion 30 of housing 14. The diameter of the aperture 28 is preferably approximately greater than the diameter of envelope 12 but can also be about the same diameter or approximately smaller than envelope 12. The gimbal or ring 20 includes a first pair of opposed through holes 42 and a second pair of opposed through holes 44. The first pair of holes 42 defines a first axis of gimbal-G1 and the second pair of holes 44 defines a second axis of gimbal-G2. The first axis of gimbal-G1 and the second axis of gimbal-G2 intersect with each other at 90 degrees. Each of the holes 42 and 44 is separated from the adjacent holes by approximately 90 degrees.

The counterbalance 18 has an annular upper portion 46 and lower portion 47. The annular upper portion 46 forms a seating for the candle 16. An approximately flat top surface 48 of the lower portion 47 has a circular groove 50 that is adapted to receive a magnetic disc 52. Candle 16 is removably mounted in the annular upper portion 46 so that a bottom surface of the candle 16 is in contact with top surface of the counterbalance 48. In one embodiment, the magnetic disc 52 is a Neodymium disc magnet with ⅜-inch diameter and 1/16-inch thickness it being understood that other materials and geometries are possible. The counterbalance 18 includes a pair of countersinks, indentations, holes or recesses 54 on an outer periphery of gimbal 20. The countersinks 54 define an axis of counterbalance-C.

Referring to FIGS. 2A and 2B, another embodiment of the counterbalance 18 is shown. The counter balance 18 includes annular upper portion 46′ and lower portion 47′. The annular upper portion 46′ forms a recess 49′ that is advantageously used to collect wax and help deter wax spillage. An approximately flat top surface 48′ of the lower portion 47′ defines an approximately round groove 50′ that is adapted to receive the magnetic disc 52. The pair of countersinks, indentations, holes or recesses 54′ define an axis of counterbalance-C.

Referring to FIG. 3, the candle 16 includes a candle wick 56, a wax ring 58, a wick tab 60 (preferably metallic), and an aluminum cover or casing 62. The wick tab or sustainer 60 is a round flat metal disc with a hole in the middle for the wick 56. The tab 60 secures the end of the wick 56. The candle 16 with the wick 56 and tab 60 is positioned in the aluminum casing 62. The aluminum casing advantageously prevents spillage of wax when the candle is lighted, and the paramagnetic properties of the tab 60 provide a means for the candle 16 to be removably secured to the magnetic disc 60 attached to the annular upper portion 46 of the counterbalance 18.

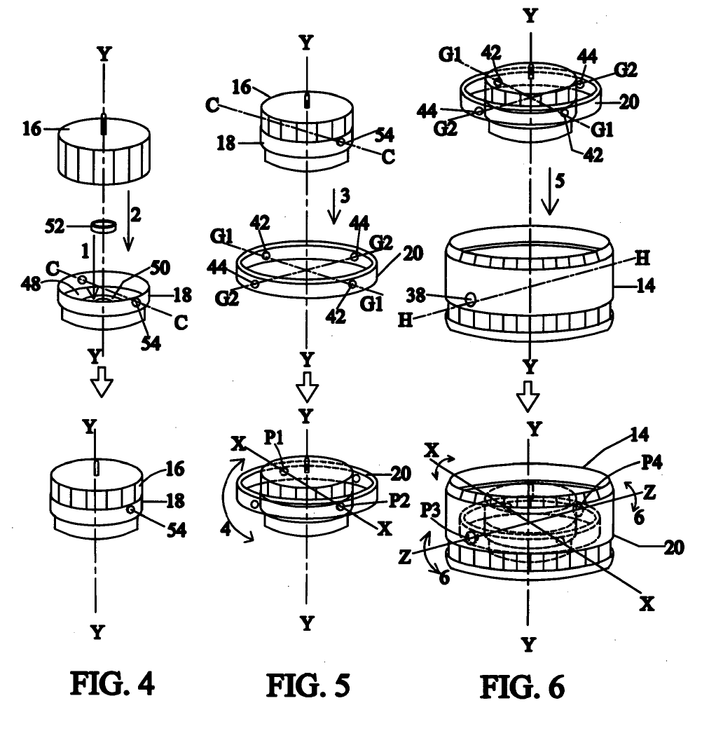

Referring to FIGS. 4, 5 and 6, a method of assembly of the housing 14 with counterbalance 18, gimbal 20, candle 16 and magnetic disc 60 is described. In a first step, the magnetic disc 52 is fixedly positioned in the predefined circular groove 50 in the counterbalance 48 as indicated by arrow 1. The thickness of the disc 52 is such that the disc 52 and a top surface of the counter weight 48 form an approximately flat surface when the disc 52 is completely inserted in the circular groove 50 in the counterweight 48.

In a second step, the candle 16 is inserted in the counterbalance 18 along axis-Y as indicated by arrow 2. In the second step, a bottom surface of the candle 16 rests on the approximately flat surface defined by the magnetic disc 52 and a top portion of the counterbalance 18. In step 3, the counterbalance 18 with the candle 16 is positioned in the gimbal 20 along axis-Y. Arrow 3 indicates the direction of insertion of the counterbalance 18.

In the third step, the counterbalance 18 is mounted in the gimbal 20 preferably with a first pair of pivot members P1 and P2. The first pair of pivot members P1 and P2 defines a first pivotal axis-X. The first pivotal axis-X passes through the center of each countersink 54 and opposed hole 42. The counterbalance 18 is mounted in the housing 14 so that the first pivotal axis-X is collinear with the axis of counterbalance-C and the first axis-G1 of gimbal 20.

In this preferred embodiment, a pair of steel bearings acts as pivot members P1 and P2 such that the pair of bearings sits between the countersinks 54 of the counterbalance 18 and respective holes 44 of the gimbal 20. It is, however, understood that the pivot members P1 and P2 can be any pivot members, known in the art. For example, the pivot members may be a pair of shafts or a pair of pins.

The counterbalance 18 may be rotated about the axis-X in clockwise and counter clockwise directions relative to the gimbal 20 in the space defined by the perimeter of the gimbal 20. The direction of movement of the counterbalance 18 is indicated by a curved arrow 4.

In step four, the gimbal 20 with the counterbalance 18 is positioned in the housing 14 along axis-Y in a direction indicated by arrow 5. Gimbal 20 is mounted in the housing 14 preferably with a second pair of pivot members P3 and P4. The second pair of pivot members defines a second pivotal axis-Z. The second pivotal axis-Z passes through the center of holes 38 and 44. The gimbal 20 is positioned in the housing 14 so that the second axis-G2 of gimbal 20 and axis-H of housing 14 are collinear with the second pivotal axis-Z.

In this preferred embodiment, a pair of steel bearings acts as pivot members P3 and P4 such that the pair of bearings sits between the holes 44 of the gimbal 20 and respective holes 38 of the housing 14. The gimbal 20 is rotatable relative to the housing about the axis-Z. The gimbal 20 has a freedom of rotation about the axis-Z in clockwise and counter clockwise directions as indicated by arrow 6. Enclosure 12 is preferably fixedly fastened to the top of housing 14 after the complete assembly of the housing 14. The pivotal axis-X is preferably always perpendicular to the pivotal axis-Y.

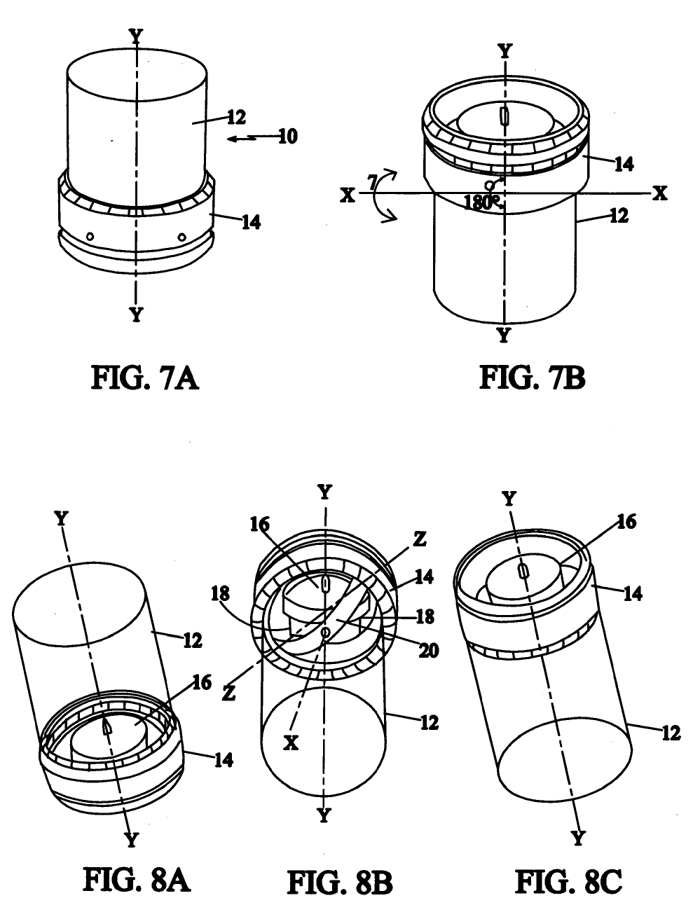

Referring to FIGS. 7A and 7B, in the first position, the candle holder 10 is upright along axis-Y. Enclosure 12 and housing 14 are approximately longitudinally aligned along the vertical axis-Y. In the second position, the candle holder 10 is inverted along axis-Y. The second position of holder 10 is achieved by preferably rotating the holder 10 about axis-X in a clockwise or counter clockwise direction as indicated by arrow 7. It is understood, however, that the candle holder 10 can be inverted about any other suitable axis to attain the second position. The candle holder 10 is rotated by approximately 180 degrees from the first position to the second position.

Referring to FIGS. 8A, 8B and 8C, the first position, an intermediate position and the second position of the candle holder 10 are shown respectively. Candle 16 remains consistently upright while rotating the candle holder 10. In an intermediate position, the orientation of the gimbal 20 and the housing 14 is changed to maintain the candle 16 approximately upright. The candle 16 remains consistently upright by virtue of the combined effect of the counterbalance 18 and the gyroscopic arrangement of counterbalance 18, gimbal 20, and housing 14.

The counterbalance 18 is heavier than the candle 16 that is mounted on the top of the counterbalance onto surface 48. When the orientation of the housing 14 and enclosure 12 are changed from the first position to any random position, the weight of the counterbalance 18 substantially maintains the counterbalance 18 in a position with the heavier side 47 closer to the earth's surface due to gravitational forces. As the housing 14 and enclosure 12 are rotated to the second (inverted) position, the counterbalance 18 is substantially maintained in the original upright position. Movement of the housing 14 and enclosure 12 about axis-X or axis-Z of gimbal 20 has minimal affect on the position of the candle 16 which remains substantially upright.

The rotation of the counterbalance 18 about axis-X of the gimbal advantageously rotates the gimbal 20 about the axis-Z relative to the housing 14. The tendency of the candle 16 to remain upright is supported by the motion of the counterbalance 18 and the gimbal 20 relative to the housing 14. The vertical axis-Y is preferentially always perpendicular to axis-X of the gimbal and axis-Z of the housing.

The earth's gravitational pull keeps the counterbalance 18 centered and candle 16 upright within enclosure 12. The gimbal 20 allows counterbalance 18 to continue to maintain a position relative to the earth's surface while the orientation of gimbal 20 and the housing 14 is being changed. The embedded neodymium magnet 52 within the counterbalance 18 in recess 50 advantageously holds the wick tab 60 of the candle 16 by virtue of the magnetic force of attraction between the tab 60 and the neodymium magnet 52.

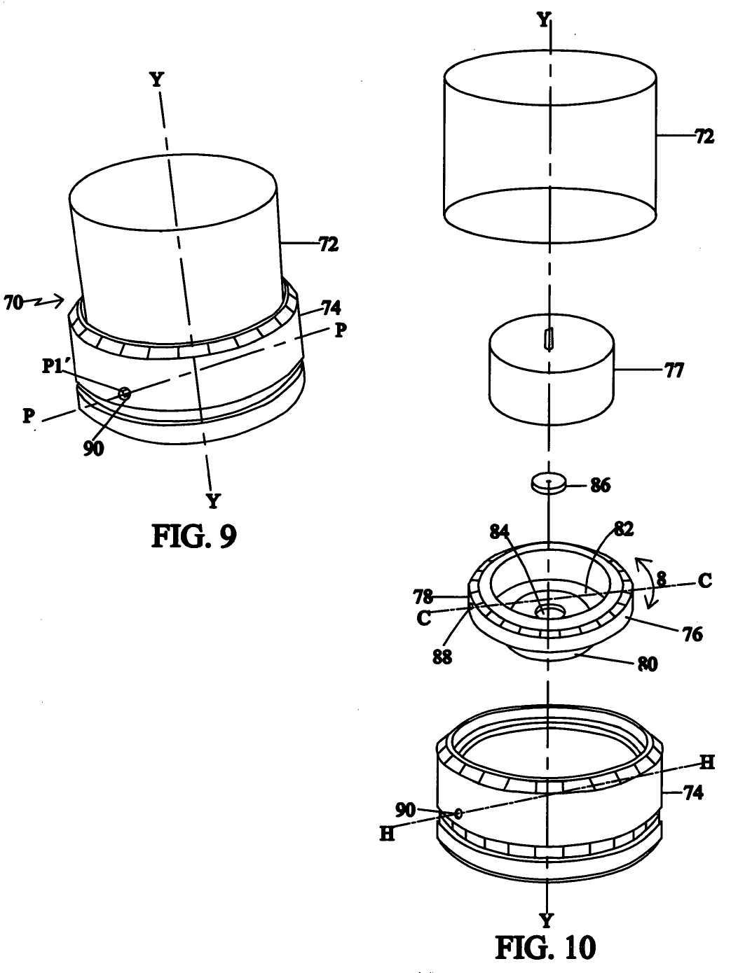

Referring to FIGS. 9 and 10, in another embodiment, the candle holder 70 includes an enclosure 72 that is fixedly attached to housing 74. A counterbalance 76 is pivotally positioned in housing 74, preferably about centrally between the top and bottom of housing 74. A candle 77 is removably positioned in the counterbalance 76. Candle holder 70 has a first upright position and a second inverted position along axis-Y.

The counterbalance 76 includes an annular upper portion 78 and lower portion 80. Annular upper portion 78 forms a seating for the candle 77. An approximately flat top surface 82 of the lower portion 80 defines an approximately circular groove 84 that is adapted to receive a magnetic disc 86. Candle 77 is preferably mounted in the annular portion 78 so that the bottom surface of candle 77 is in contact with surface 82 of the counterbalance 76. In one embodiment, the magnetic disc 86 has a ⅜-inch diameter and 1/16-inch thickness. The side 78 of counterbalance 76 includes a pair of opposed holes, countersinks or indentations 88 that define axis-C of counterbalance 76.

The counterbalance 76 is mounted in the housing 74 preferably with a pair of pivot members. In this embodiment, a pair of steel bearings acts as pivot members such that the pair of bearings sits between the countersinks 88 of the counterbalance 76 and respective holes or indentations 90 of housing 74. It is, however, understood that the pivot members can be any pivot members, known in the art, such as, shafts, set screws, or pins. It is also understood that a single pivot member, such as, for example, a rod, shaft or pin could be used with holes through both the counterbalance 76 and housing 74 to act as a pivot axis. A single wire with a generally circular configuration to hold the counterbalance could also be used as a pivot member if passed through the holes in the housing 74.

An axis-P passes through the center of holes 88 and 90, and the pair of pivot members. Counterbalance 76 is rotatable about the axis-P in clockwise and counter clockwise directions relative to the housing 74 in the space defined by housing 74. The direction of rotation of the counterbalance 76 along axis-C is indicated by curved arrow 8.

The candleholder 70 is rotated about axis-P from the first upright position to the second inverted position. The candle 77 remains substantially upright or vertical by virtue of the counterbalance 76. The counterbalancing effect and weight of the counterbalance will allow candle 77 in the candleholder 70 to remain consistently upright in all orientations of candle holder 70.

Referring to FIGS. 8A, 8B and 8C in operation, the candle holder 10 is initially in the first position depicted by FIG. 8A, with the lower surface of housing 14, opposite enclosure 12, positioned perpendicularly to axis-Y. The candle holder 10 is preferably positioned on an approximately flat surface, such as a table, a counter or a desk. The candle holder 10 is then lifted from the surface and rotated as depicted in FIG. 8B resulting in the inverted orientation depicted by FIG. 8C. While inverting the candle holder 10, the gimbal 20 rotates about its axis-X and the candle holder 10 rotates relative to the counterbalance 18 due to gravity. The combination of the motions of gimbal 20 and the gravitational forces on counterbalance 18 result in the candle 16 remaining in an approximately upright position. While in the inverted position a new candle 16 can be inserted in the counterbalance 18, or an existing candle in counterbalance 18 can be replaced with a new candle 16. The candle 16 can then be lit and the candle holder 10 may be returned to the first upright position in FIG. 8A.

The candle 16 remains consistently upright even if the holder 10 is tilted either intentionally or by accident. By substantially maintaining the candle 16 in a vertical orientation, the candle holder 10 helps to prevent the spillage of molten wax. The candle holder 10 may be moved from one point to another even if the candle 16 has been lit. The magnetic attraction between the neodymium magnet 52 and wick tab 60 advantageously secures the candle 16 in counterbalance 18. Indentation 40 provides a seat for mounting enclosure 12 onto housing 14. The counterbalance 18 holds the magnetic disc 52 in position in recess 50. The holes in the outer peripheral portion of the housing 14 are for ventilation and introduce fresh air into housing 14 and enclosure 12.

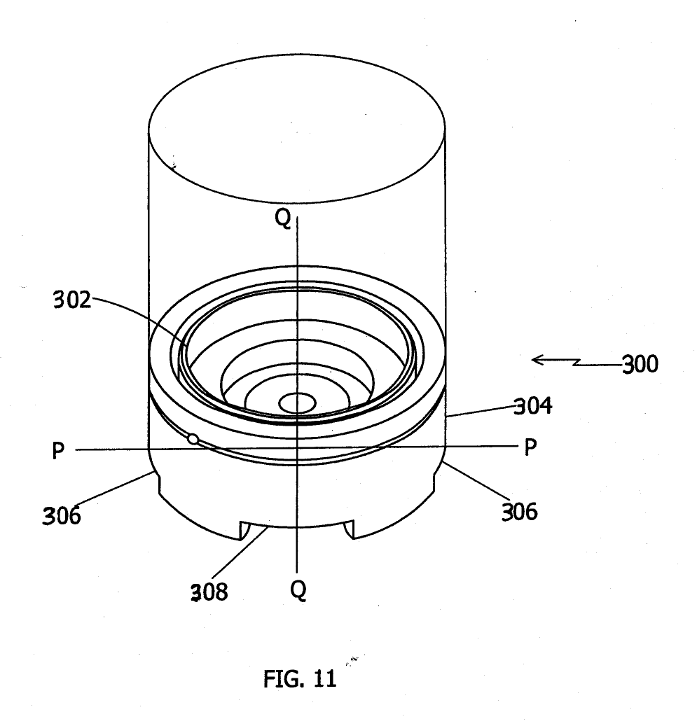

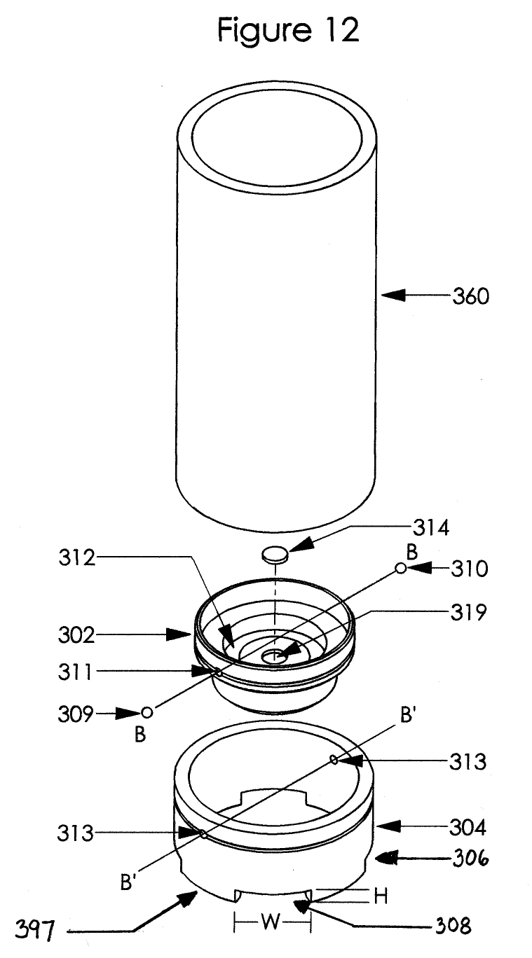

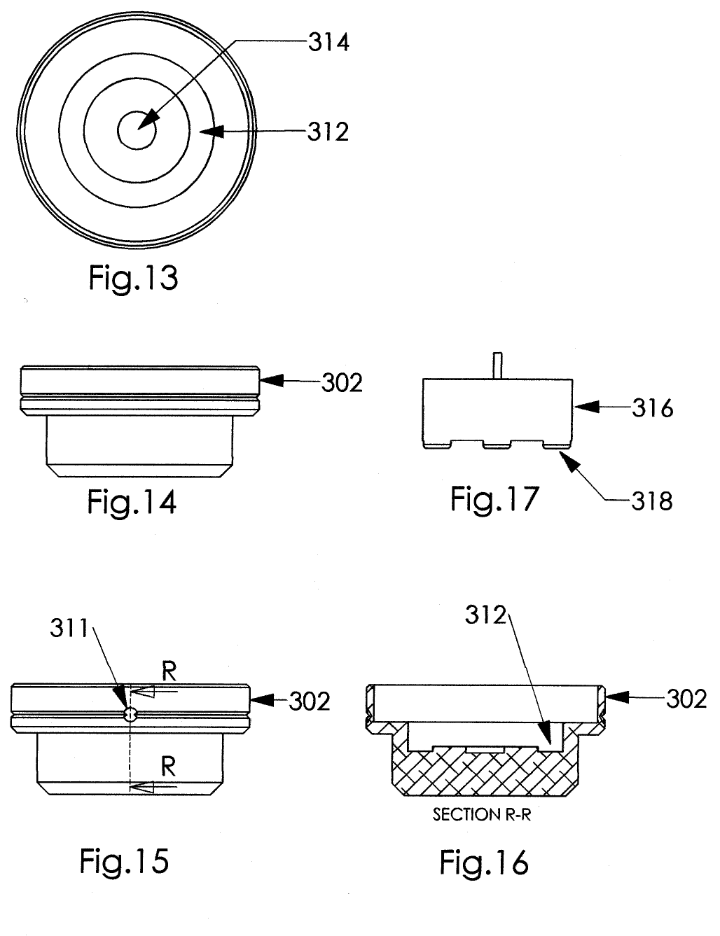

Referring to FIGS. 11-17, another embodiment of the candle holder 300 in accordance with the present invention is described. The candle holder 300 includes a candle (not shown) that is removably positioned in a weighted counterbalance 302 pivotally positioned in a cylindrical housing 304. Housing 304 is preferably a metallic material such as aluminum or brass to help maintain the candle holder in a stable position and for a sturdy base that has more impact resistance than fragile materials such as, for example, glass. Preferably, the counterbalance 302 is about centrally located within cylindrical housing 314 in both the horizontal and vertical directions. Housing 304 includes at least one predefined notch 306 and/or 308 in the bottom end portion of the housing 304. With a candle lit, as compared to a device without any notch present, the at least one notch 306 and/or 308 increases air flow and oxygen to the candle, helps dissipate heat, and also acts as an opening for the candle light to pass through. In the embodiment shown in FIGS. 11 and 12, housing 304 includes four notches 306 or 308 positioned in two opposed pairs around the bottom of housing 304. A first pair of opposed notches 306 are symmetrical along axis-P and a second pair of opposed notches 308 are symmetrical along axis-Q such that axis-P and axis-Q approximately normally intersect with each other. Notches 306 and 308 in the embodiment shown in FIGS. 11 and 12 have an appearance similar to parapets when the device is inverted and the notches 306 and 308 are on top of the device. With the notches 306 and 308, the bottom or distal end of housing 314 has legs 397 for support of the housing 14 on a surface.

Preferably, for a 3-inch diameter housing 314, the size of each at least one notch 306 and/or 308 is approximately 1.15-inches wide as represented by dimension W and approximately 0.25-inches high as represented by dimension H. Accordingly, the area of the each notch is preferably approximately 0.3 square inches.

Using a 3-inch diameter housing and counterbalance both made of aluminum or brass with a lit candle therein in a room at about 70 degrees F., each of the four notches 306 and 308 sized at about 1.15-inches wide and 0.3-inches high helps to maintain a candle holder between 20-30 degrees F. cooler than a candle holder without the notches 306 and 308 under the same conditions. Accordingly, notches 306 and/or 308 help to maintain the candle holder at least below 120 degrees F. which is the observed temperature at which human skin begins to burn.

The optimal sizing of the at least one notch 306 and/or 308, and the resulting legs 397, depends upon many variables, including without limitation, the number and location of the notches, the materials of construction of the counterbalance 302 and the housing 304, the thickness of the housing, the type of candle used and the amount of heat generated, and the heat absorption and dissipation characteristics of the materials of construction. Applicant has discovered that larger notches do not necessarily translate into greater heat dissipation because the housing sometimes assists with the absorption and dissipation of the heat.

Counterbalance 302 is pivotally positioned in the housing 304 with a pivoting means. In FIGS. 11-12, the pivoting means is shown by way of example as a pair of ball bearings 309 and 310, it being understood that other devices such as pins, shafts or screws can be used, along axis-B positioned on a pair of predefined opposed countersinks, holes or recesses 311 in outer periphery of counterbalance 302. Countersinks 311 in counterbalance 302 define a pivotal axis-B. The holes 313 in housing 304 define a pivotal axis-B′. The pivot members 309 and 310 are positioned between holes 313 defined in housing 304 and countersinks 311 defined in counterbalance 302. The pivotal axis-B and the pivotal axis-B′ are collinear with each other while the counterbalance 302 is positioned in the housing with the pivot members 309 and 310.

In the embodiment shown in FIGS. 11-17, counterbalance 302 also includes a circular recess 312 defined in close proximity with and around a magnetic disc 314 that is fixedly positioned in a predefined circular groove 319 in the lower portion of the counterbalance 302. It is understood that the recess 312 is defined around the magnetic disc 314, within the annular portion of counterbalance 302 in which a candle 316 is seated. In this embodiment, the counterbalance 302 receives candle 316 having a circumferential rim or legs 318 as shown in FIG. 17. When candle 316 is set within counterbalance 302, rim 318 is substantially flush with the surface of recess 312. Having this configuration, counterbalance 302 is advantageously compatible with regular candles having flat bottoms as well as candles with a rim or legs 318 with both candle configurations capable of engaging magnetic disc 314.

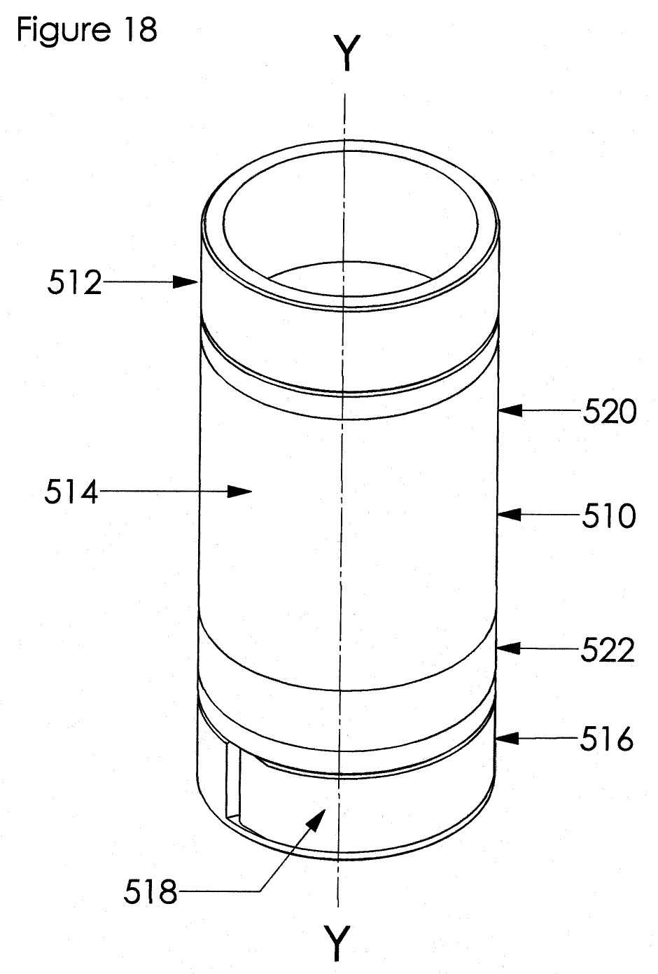

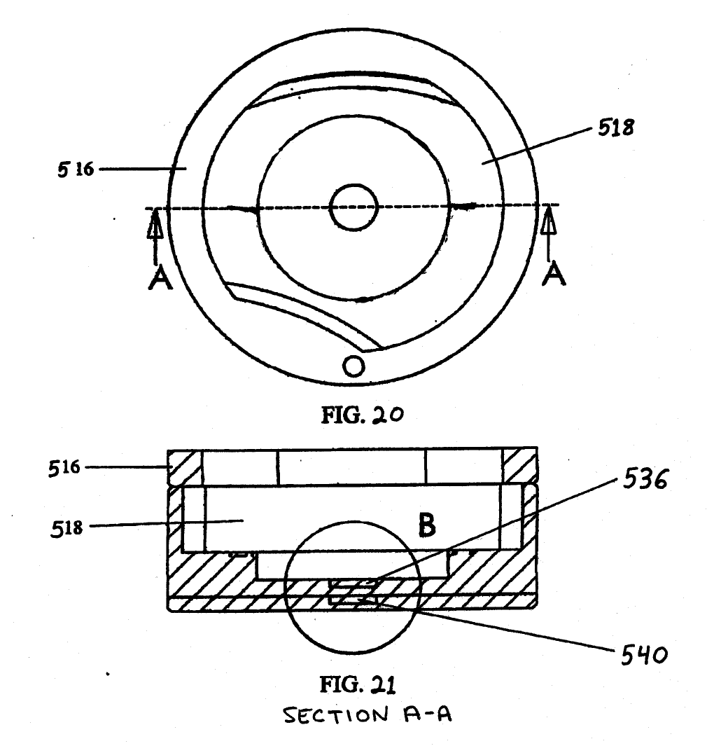

Referring to FIGS. 18-21, yet another embodiment of the candle holder in accordance with the principles of the present invention is described. The candle holder 510 includes an enclosure or cover comprising two enclosures or pieces 512 and 514 fixedly attached together, it being understood that the enclosure or cover for the device may be a single piece as heretofore disclosed or it may be a combination of more than two pieces, and a housing 516 having a proximal end 533 and a distal end 531. Two piece enclosure 514 and 512 may be materials such as metal and glass, respectively. Two piece enclosure 514 and 512 is fixedly attached or coupled with the proximal end 533 of housing 516 on either side of the combined enclosure, preferably with the glass in the middle, the enclosure 514 side of the combined enclosure 512/514 along a common axis-Y. A candle tray 518, configured to hold a candle, is pivotally secured to housing 516.

The enclosures 512 and 514 may be fastened to each other and/or housing 516 using one or more methods know in the art including, without limitation, epoxy, heat resistant glue, etc.

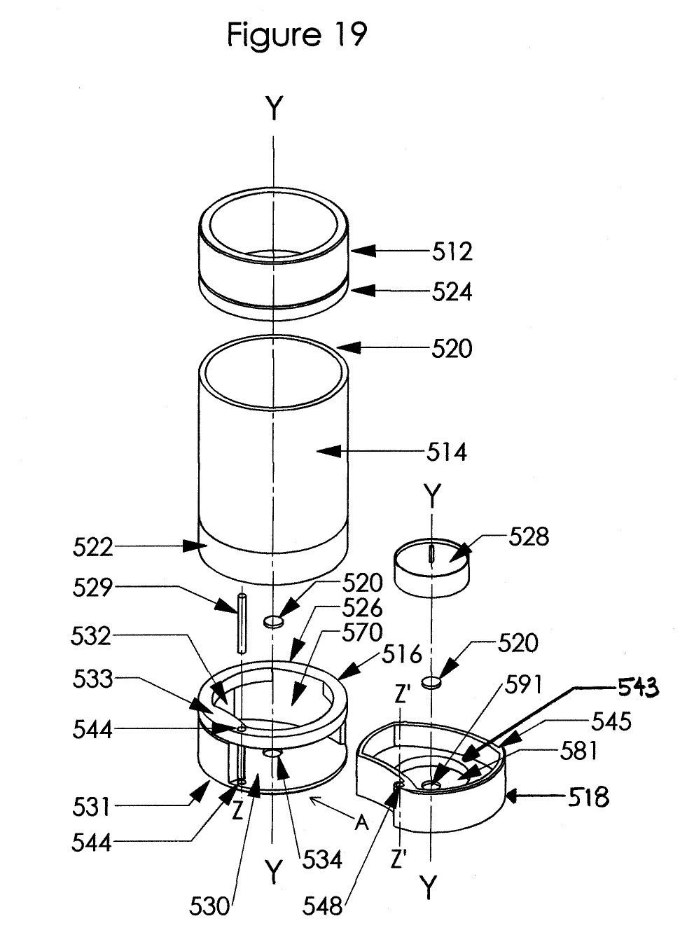

The size of the device, including the heights of housing 516 and enclosures 512 and 514 are not limited to the configurations or proportions shown in FIGS. 18-19 and may include other heights and relative proportions. For example, the height ratios of the enclosures 512 and 514 shown in FIGS. 18-19 is approximately one to three but can be varied to create different effects visually, and/or when the candle is lit in the device 510. Different styles of glass or stone or other materials can also be used for enclosures 512 and/or 514 to create different effects. Also, in FIGS. 18 and 19, the height of enclosure 512 and housing 516 is shown about equal but other differing heights are contemplated and possible.

Referring to FIG. 19, housing 516 is provided with radially and collinearly aligned, diametrically opposed, mounting holes 544 that are positioned along axis-Z. Candle tray 518 also includes a mounting or through hole or bore 548 positioned along an axis-Z′. Mounting pin or rod 529 is provided for pivotally mounting candle tray 518 within housing 516, wherein pin 529 is inserted into respective hole 544 on housing 534 and into respective bore 548 on candle tray 518. The bore 548 and its axis-Z′ aligns with respective mounting holes 544 and its axis-Z placing the bore 548 in a collinear configuration with holes 544. Candle tray 518 pivots through a first aperture 530 in the peripheral wall of housing 516 about axis-Z.

A second aperture 532 in the peripheral wall of housing 516 is provided. The second aperture 532 is used to help begin pivoting candle tray 518 out of housing 516 using one's hand or finger. Second aperture 532 is preferably located on the opposite side of the housing 516 peripheral wall as first aperture 530.

Candle tray 518 includes a closing lip or notch 545. The lip 545 helps create a finished appearance when the candle tray 518 is in the closed position within housing 516 and it could also function as a stop for the distance that candle tray 518 pivots or slides into housing 516.

Candle tray 524 comprises a body with planar surface 543 further containing a recessed, approximately cylindrical, cavity 581 that is adapted to receive a candle 528. A second recessed, approximately cylindrical, cavity 591 within cavity 581 is configured to accommodate a magnetic disc 520. Alternatively, candle tray 518 can be configured without the cavity 581 for candle 528 and with one recessed, approximately cylindrical, cavity 591 within planar surface 543 configured to accommodate a magnetic disc 520. In such a configuration, the magnetic forces maintain the candle 528 in position on planar surface 543 on candle tray 518.

Housing 516 includes an approximately circular aperture 570 that is defined by an open proximal end 533 and a closed distal end 531. In alternative embodiments, the proximal end 533 of housing 516 also includes a lip or ridge along the outer periphery of housing 516 for attachment of one of the enclosures 512 or 514. The inside bottom surface of housing 516 is generally planar and in the embodiment shown in FIGS. 18-20, includes an approximately cylindrical cavity 534 configured to accommodate a magnetic disc 520.

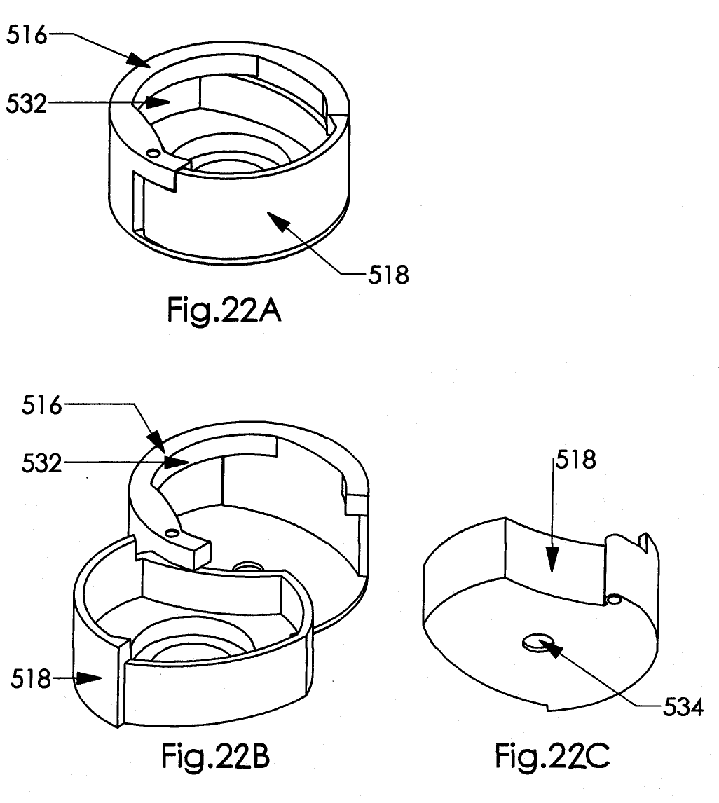

When candle tray 518 is pivoted about axis-Z of rotation through aperture 530 of housing 516 into a closed position as shown in FIG. 22A, magnetic discs 520 (with poles similarly oriented) attract each other pulling the candle tray 518 into housing 516.

Referring to FIGS. 22A-C (showing the housing 518 and candle tray 516 without any enclosure and with generally planar surface on the underside of candle tray 516 comprising a recessed, approximately cylindrical, cavity 534 that is adapted to a magnetic disc 520), the closed first position and the open second position of candle tray 518 are shown in 22A and 22B respectively, and the underside of candle tray 518 is shown in FIG. 22C. Initially tray 518 is in the first closed position. The user pivotally slides out candle tray 518 to the second position. The user preferably begins the opening process by pushing a finger into aperture 532 thereby breaking the magnetic force of attraction between magnetic discs 520 (not shown) and pushing the candle tray 518 out of housing 516 through aperture 530. Alternatively, lip 545 (or other means for gripping the candle tray such as, for example, handles or knobs attached to the candle tray 518) may be used to pull the candle tray 518 out of housing 516. Candle tray 518 slides out of housing 516 while pivoting about axis-Z until the candle tray reaches a fully open position where the candle 528 is fully accessible, can be lit, blown out, set in place, and/or replaced. Candle tray 518 is then pushed back to the closed position pivoting about axis-Z. Forces of attraction between magnetic discs 520 (not shown) in the housing 516 and the candle tray 518 help keep the candle tray 518 in the closed position and decrease the chance for the candle tray 518 to unintentionally pivot out of the housing 516.

First aperture 530 also helps to keep the candle tray 518 in alignment with the candle tray holder in the partially and fully open positions.

While the above description and illustrations constitute preferred or alternate embodiments of the present invention, it will be appreciated that numerous variations may be made without departing from the scope of the invention.

What is claimed is:

1. A candle holder comprising:
a counterbalance, the counterbalance pivotally positioned in a gimbal that is pivotally positioned in a cylindrical housing;
an enclosure that is fastened with a proximal end of the housing;
a first pair of pivot members that defines a first pivotal axis, each pivot member connecting the counterbalance and the gimbal;
a second pair of pivot members that defines a second pivotal axis, each pivot member connecting the gimbal to the housing; and
wherein said distal end of said housing is configured for stable placement upon a flat surface further comprising at least one notch through the peripheral wall of said housing.

2. The candle holder of claim 1, wherein the counterbalance includes an annular upper portion and a lower portion, the annular upper portion is adapted to receive a candle, the lower portion includes a top surface that has a groove configured to receive a magnet.

3. The candle holder of claim 1, wherein the gimbal includes a first pair of opposed holes and a second pair of opposed holes, the first pair of opposed holes in line with the first pivot axis and the second pair of opposed holes in line with the second pivot axis.

4. The candle holder of claim 1, wherein the housing includes a pair of opposed through holes on an outer periphery of the housing, the pair of opposed holes in line with the second pivot axis.

5. The candle holder of claim 1, wherein the housing includes an aperture with a diameter that is approximately greater than a diameter of the enclosure.

6. The candle holder of claim 1, wherein the housing includes an indentation in proximity with a proximal end along an inner periphery of the housing, the indentation is adapted to provide a seating to the bottom end of the enclosure.

7. The candle holder of claim 1, wherein the first pivotal axis and the second pivotal axis intersect with each other at approximately 90 degrees.

8. The candle holder of claim 1, further comprising a candle seated in the annular upper portion of the counterbalance, wherein the candle is maintained in an upright position when the candle holder is rotated.

9. The candle holder of claim 8, wherein the candle is removable and replaceable when the candle holder is positioned with the distal end of the housing above the enclosure.

10. The candle holder of claim 8, wherein the candle includes a wax ring having a wick and a tab, the wax ring positioned in a cylindrical casing to prevent spillage of wax.

11. The candle holder according to claim 10, wherein said tab is magnetically attracted to a magnet positioned in said counterbalance.

12. A candle holder comprising:
a generally cylindrically shaped housing having an open proximal end, an open distal end, and an aperture; wherein said distal end of said housing is configured for stable placement upon a flat surface further comprising at least one notch through the peripheral wall of said housing;
a counterbalance configured to hold a candle, said counterbalance configured to fit within said aperture of said housing and pivotally attached to said housing;
a generally cylindrically shaped enclosure comprising an open proximal end, an open distal end, and an aperture, said enclosure fixedly attached to said proximal end of said housing at an end of said enclosure;
wherein, when said candle holder is rotated about a pivot axis of said counterbalance relative to said candle holder said counterbalance maintains a generally upright position.

13. The candle holder according to claim 12, wherein said counterbalance is approximately centrally located between said proximal end and said distal end of said housing.

14. The candle holder according to claim 13, further comprising at least one pivot member pivotally attaching said counterbalance and said housing.

15. The candle holder according to claim 14, wherein said at least one pivot member is one from the group consisting of a shaft, rod, post and pin.

16. The candle holder according to claim 15, wherein said at least one pivot member is one from the group consisting of a pair of ball bearings, shafts, screws, posts and pins.

17. The candle holder according to claim 12, wherein said counterbalance further comprises a magnet within a groove within said counterbalance.

18. The candle holder according to claim 12, wherein said housing further comprises a plurality of holes through one side of said housing positioned between the proximal and distal end.

19. The candle holder according to claim 12, further comprising a candle which includes a wax ring having a wick and a tab, the wax ring positioned in a cylindrical casing to prevent spillage of wax.

20. The candle holder according to claim 19, wherein said tab is metallic and is magnetically attracted to a magnet positioned in said counterbalance.

21. A candle holder comprising:
a generally cylindrically shaped housing having an open proximal end, a closed distal end, and a pair of apertures though generally opposite sides of said housing;
a candle tray with a mounting hole positioned in line with a pivot axis, said candle tray configured to hold a candle and fit within said housing and pivotally attached to said housing at said pivot axis;
an enclosure fastened with a proximal end of the housing;
a pivot member between the proximal and distal end of the housing that defines said pivot axis.

22. The candle holder of claim 21, wherein said housing comprises a generally planar surface on the upper portion of said distal end further containing a groove with a magnet.

23. The candle holder of claim 22, wherein said candle tray includes a body with planar surface having a top side and a bottom side further comprising a recessed cavity on said bottom side comprising a groove configured to receive a magnet.

24. The candle holder according to claim 23, wherein the poles of said magnets discs are oriented in similar orientations relative to each other.

25. The candle holder according to claim 21, wherein said pivot member is one from the group consisting of a pin, shaft, a pair of ball bearings, a pair of pins, a pair of shafts.

26. The candle holder of claim 21, wherein said candle tray includes a body with planar surface having a top side and a bottom side further comprising a recessed cavity on said top side configured to receive a candle, said cavity comprising a groove configured to receive a magnet.
